(19) United States
(12) Patent Application Publication
(10) Pub. No.: US 2017/0134551 A1
(43) Pub. Date: May 11, 2017

(54) Retrieving Caller Identification Information in Mobile Devices

(71) Applicant: QUALCOMM Incorporated, San Diego, CA (US)

(72) Inventors: Bhaskara Viswanadham Batchu, Hyderabad (IN); Sharad Shahi, Boulder, CO (US); Prabhanjan Reddy Pingili, Hyderabad (IN); Reza Shahidi, San Diego, CA (US); Ejazahmed Yergudi, Haliyal (IN)

(21) Appl. No.: 14/935,879

(22) Filed: Nov. 9, 2015

(51) Int. Cl. H04M 1/57; H04W 4/16

(52) U.S. Cl. CPC H04M 1/57; H04W 4/16

(57) ABSTRACT

Various embodiments include methods for a multi-subscription wireless communication device to obtain caller identification (ID) information for a call coming in on a first subscription while on a call on a second subscription. In various embodiments, when the second subscription is supporting a voice call and a page message for the first subscription is received from a network, the wireless communication device may exclude one or more fields from a page response message from the first subscription to the network, blindly accept a proposed service option sent by the network, and receive caller ID information from the network. In some embodiments, one or more fields from a page response message may include at least one of an additional pilots field and an alternate service option list. Receiving caller ID information from the network may be performed when the first subscription cannot support a proposed service option sent by the network.

### BACKGROUND

Some designs of mobile communication devices—such as smart phones, tablet computers, and laptop computers—contain one or more Subscriber Identity Module (SIM) cards that provide users with access to multiple separate mobile telephony networks. Examples of mobile telephony networks include Third Generation (3G), Fourth Generation (4G), Long Term Evolution (LTE), Time Division Multiple Access (TDMA), Code Division Multiple Access (CDMA), CDMA 2000, Wideband CDMA (WCDMA), Global System for Mobile Communications (GSM), Single-Carrier Radio Transmission Technology (1×RTT), and Universal Mobile Telecommunications Systems (UMTS). A SIM may utilize a particular radio access technology (RAT) to communicate with its respective network.

Multi-SIM mobile communication devices have become increasingly popular because of their flexibility in service options and other features. For example, a multi-SIM multi-active (MSMA) device is a type of multi-SIM mobile communication device configured with multiple radio frequency (RF) resources and multiple SIMs. One example of a MSMA device is a dual-SIM dual-active (DSDA) device with two RF resources and two SIMs/subscriptions. Each SIM, or subscription, may utilize one or more RF resources for communication and thus multiple subscriptions may be actively communicating at the same time. For example, two subscriptions may utilize separate RF receive chains for receiving information from their respective networks. However, the two subscriptions may share a single RF transmit chain for transmitting information.

One subscription in a DSDA device may be in an active voice call on the mobile communication device when the idle subscription receives a page message from its respective network. The page message indicates an incoming call on the idle subscription. The idle subscription may retrieve the caller identification (ID) information from the network in order to display the caller ID information to the user. The process for obtaining the caller ID information may include multiple message exchanges between the idle subscription and its respective network. If the active and idle subscriptions share a RF transmit chain, the message exchange process by the idle subscription to obtain the caller ID information may disrupt the voice call on the active subscription. This may lead to degradation of voice call quality.

### SUMMARY

Various embodiments include methods performed by a wireless communication device configured to support a first subscription and a second subscription for obtaining caller identification (ID) information. Various embodiments may include receiving a page message for the first subscription from a network, determining whether the second subscription is currently engaged in a voice call, and in response to determining that the second subscription is currently engaged in the voice call, excluding one or more fields from a page response message sent from the first subscription to the network, blindly accepting a proposed service option sent by the network, and receiving caller ID information from the network. In some embodiments, one or more fields from a page response message may include at least one of an additional pilots field and an alternate service option list. In some embodiments, receiving caller ID information from the network may be performed even when the first subscription cannot support a call using the proposed service option sent by the network. Some embodiments may further include refraining from sending one or more null frames to the network. In some embodiments, the first subscription and the second subscription may share a radio frequency (RF) transmit chain of the wireless communication device. In some embodiments, the page message may include the proposed service option. In some embodiments, the caller ID information may be included in an alert with information message sent by the network.

Further embodiments include a wireless communication device having a memory, a radio frequency resource and a processor configured with processor-executable instructions to perform operations of the methods described above. Further embodiments include a wireless communication device having means for performing functions of the methods described above. Further embodiments include a non-transitory processor-readable medium having stored thereon processor-executable instructions configured to cause a processor of a wireless communication device to perform operations of the methods described above.

### BRIEF DESCRIPTION OF THE DRAWINGS

The accompanying drawings, which are incorporated herein and constitute part of this specification, illustrate exemplary embodiments, and together with the general description and the detailed description given herein, serve to explain the features of the disclosed systems and methods.

FIG. 1 is a communication system block diagram of mobile telephony networks suitable for use with various embodiments.

FIG. 2 is a component block diagram of a multi-SIM mobile communication device according to various embodiments.

FIG. 3 is a call flow diagram illustrating message exchanges for obtaining caller ID information according to convention methods.

FIG. 4 is a call flow diagram illustrating message exchanges for obtaining caller ID information according to various embodiments.

FIG. 5 is a process flow diagram illustrating a method for obtaining caller ID information on a mobile communication device according to various embodiments.

FIG. 6 is a component block diagram of a mobile communication device suitable for implementing some embodiment methods.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the written description or the claims.

As used herein, the term “mobile communication device,” “multi-SIM mobile communication device,” or “multi-SIM device” refers to any one or all of cellular telephones, smart phones, personal or mobile multi-media players, personal data assistants, laptop computers, tablet computers, smart books, smart watches, palm-top computers, wireless electronic mail receivers, multimedia Internet-enabled cellular telephones, wireless gaming controllers, and similar personal electronic devices that includes one or more SIM cards, a programmable processor, memory, and circuitry for connecting to at least two mobile communication network with one or more shared radio frequency (RF) resources. Various embodiments may be useful in mobile communication devices, such as smart phones, and so such devices are referred to in the descriptions of various embodiments. However, the embodiments may be useful in any electronic devices that may individually maintain a plurality of subscriptions that utilize at least one shared RF chain, which may include one or more of antennae, radios, transceivers, etc.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a mobile communication device on a network and enable a communication service with the network. Because the information stored in a SIM enables the mobile communication device to establish a communication link for a particular communication service with a particular network, the term “subscription” is used herein as a shorthand reference to refer to the communication service associated with and enabled by the information stored in a particular SIM as the SIM and the communication network, as well as the services and subscriptions supported by that network, correlate to one another.

In the following descriptions of various embodiments, references are made to a first subscription and a second subscription. The references to the first and second subscriptions are arbitrary and are used merely for the purposes of describing the embodiments. The device processor may assign any indicator, name or other designation to differentiate the subscriptions on the mobile communication device.

A page message sent by a network to a subscription on a mobile communication device may indicate an incoming call. In response to receiving a page message, a subscription may obtain caller ID information from the network and display the information to the user. Multiple messages may be exchanged between the subscription and the network before the network sends the caller ID information. For example, the message exchange process may include a page response message, one or more acknowledgements messages, service negotiation, and service connect completion messages. After the message exchange, the network may send an alert with information message (AWIM) that includes the caller ID information.

A mobile communication device may be a MSMA device, and specifically a DSDA device having two subscriptions. The subscriptions may utilize separate RF receive chains but share a RF transmit chain. One subscription may be engaged in an active voice call when the idle subscription receives a page message from its respective network. The idle subscription then engages in the message exchange process with the network to obtain the caller ID information. However, because both subscriptions share the RF transmit chain, the message exchange process may disrupt and degrade the active voice call, especially if the idle subscription and the network conduct a protracted service negotiation. These disruptions may be minimized by shortening the message exchange process.

In overview, various embodiments provide systems and methods implemented with a processor of a mobile communication device (e.g., a multi-SIM mobile communication device) for obtaining caller identification (ID) information on a mobile communication device having a first subscription and a second subscription sharing one RF transmit chain.

The various embodiment methods may be initiated when the mobile communication device receives a page message for the first subscription from a network. The page message may include a proposed service option. In response to receiving such a page message, the processor may determine whether the second subscription is currently engaged in a voice call. The processor may exclude one or more fields from a page response message sent from the first subscription to the network in response to determining that the second subscription is currently engaged in a voice call. The fields that may be excluded from a page response message may include an additional pilots field and an alternate service option list. The processor may then blindly accept the proposed service option sent by the network regardless of whether the first subscription can support a call using the proposed service option. The processor may also refrain from sending one or more NULL frames to the network. The processor may then receive the caller ID information from the network. The caller ID information may be included in an alert with information message sent by the network.

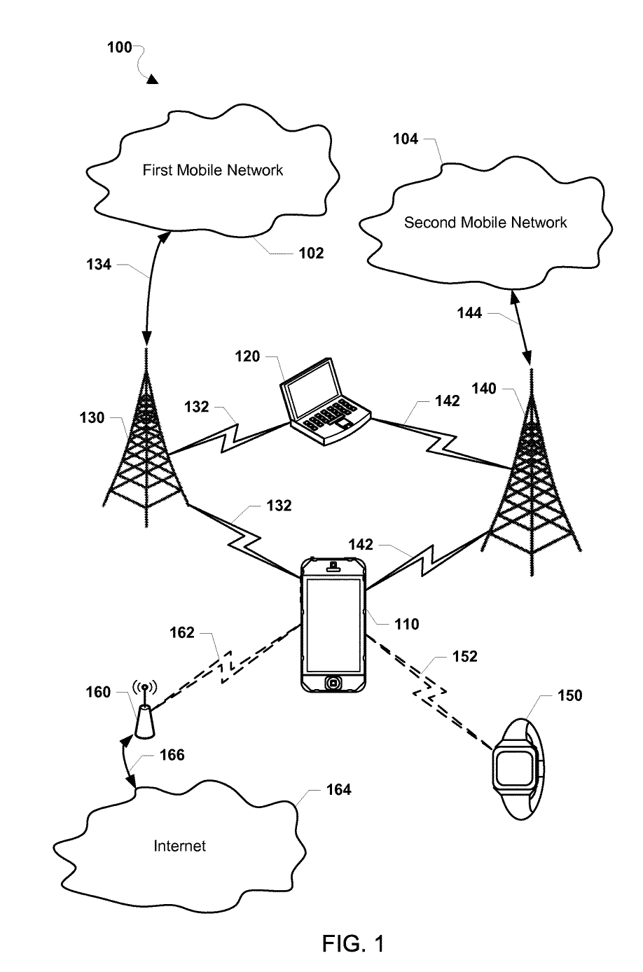

Various embodiments may be implemented within a variety of communication systems 100, such as at least two mobile telephony networks, an example of which is illustrated in FIG. 1. A first mobile network 102 and a second mobile network 104 typically each include a plurality of cellular base stations (e.g., a first base station 130 and a second base station 140). A first mobile communication device 110 may be in communication with the first mobile network 102 through a cellular connection 132 to the first base station 130. The first mobile communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second mobile communication device 120 may similarly communicate with the first mobile network 102 through the cellular connection 132 to the first base station 130. The second mobile communication device 120 may also communicate with the second mobile network 104 through the cellular connection 142 to the second base station 140. The cellular connections 132 and 142 may be made through two-way wireless communication links, such as Third Generation (3G), Fourth Generation (4G), Long Term Evolution (LTE), Time Division Multiple Access (TDMA), Code Division Multiple Access (CDMA), Wideband CDMA (WCDMA), Global System for Mobile Communications (GSM), Universal Mobile Telecommunications Systems (UMTS), and other mobile telephony communication technologies.

While the mobile communication devices 110, 120 are shown connected to the first mobile network 102 and, optionally, to the second mobile network 104, in some embodiments (not shown), the mobile communication devices 110, 120 may include two or more subscriptions to two or more mobile networks and may connect to those subscriptions in a manner similar to those described herein.

In some embodiments, the first mobile communication device 110 may optionally establish a wireless connection 152 with a peripheral device 150 used in connection with the first mobile communication device 110. For example, the first mobile communication device 110 may communicate over a Bluetooth® link with a Bluetooth-enabled personal computing device (e.g., a “smart watch”). In some embodiments, the first mobile communication device 110 may optionally establish a wireless connection 162 with a wireless access point 160, such as over a Wi-Fi connection. The wireless access point 160 may be configured to connect to the Internet 164 or another network over a wired connection 166.

While not illustrated, the second mobile communication device 120 may similarly be configured to connect with the peripheral device 150 and/or the wireless access point 160 over wireless links.

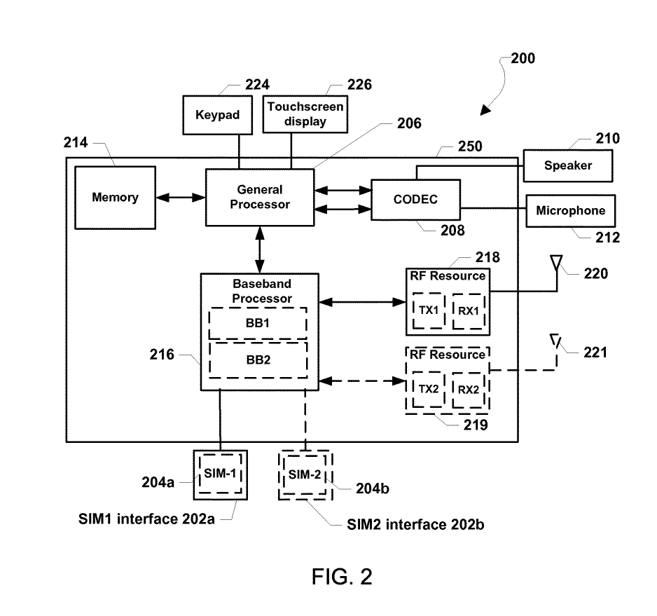

FIG. 2 is a functional block diagram of a multi-SIM mobile communication device 200 suitable for implementing various embodiments. With reference to FIGS. 1-2, the multi-SIM mobile communication device 200 may be similar to one or more of the mobile communication devices 110, 120 as described. The multi-SIM mobile communication device 200 may include a first SIM interface 202a, which may receive a first identity module SIM-1 204a that is associated with a first subscription. The multi-SIM mobile communication device 200 may also optionally include a second SIM interface 202b, which may receive an optional second identity module SIM-2 204b that is associated with a second subscription.

A SIM in various embodiments may be a Universal Integrated Circuit Card (UICC) that is configured with SIM and/or Universal SIM applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a central processing unit (CPU), read only memory (ROM), random access memory (RAM), electrically erasable programmable read only memory (EEPROM) and input/out (I/O) circuits.

A SIM used in various embodiments may contain user account information, an international mobile subscriber identity (IMSI), a set of SIM application toolkit (SAT) commands, and storage space for phone book contacts. A SIM card may further store home identifiers (e.g., a System Identification Number (SID)/Network Identification Number (NID) pair, a Home Public Land Mobile Number (HPLMN) code, etc.) to indicate the SIM card network operator provider. An Integrated Circuit Card Identity (ICCID) SIM serial number may be printed on the SIM card for identification. However, a SIM may be implemented within a portion of memory of the multi-SIM mobile communication device 200 (e.g., in a memory 214), and thus need not be a separate or removable circuit, chip or card.

The multi-SIM mobile communication device 200 may include at least one controller, such as a general processor 206, which may be coupled to a coder/decoder (CODEC) 208. The CODEC 208 may in turn be coupled to a speaker 210 and a microphone 212. The general processor 206 may also be coupled to the memory 214. The memory 214 may be a non-transitory computer-readable storage medium that stores processor-executable instructions. For example, the instructions may include routing communication data relating to the first or second subscription though a corresponding baseband-RF resource chain.

The memory 214 may store an operating system (OS), as well as user application software and executable instructions. The memory 214 may also store application data and may store exclude lists for RATs on the multi-SIM mobile communication device 200.

The general processor 206 and the memory 214 may each be coupled to at least one baseband modem processor 216. Each SIM and/or RAT in the multi-SIM mobile communication device 200 (e.g., the SIM-1 204a and/or the SIM-2 204b) may be associated with a baseband-RF resource chain. A baseband-RF resource chain may include the baseband modem processor 216, which may perform baseband/modem functions for communications with/controlling a RAT, and may include one or more amplifiers and radios, referred to generally herein as RF resources (e.g., RF resource 218, 219). In some embodiments, baseband-RF resource chains may share the baseband modem processor 216 (i.e., a single device that performs baseband/modem functions for all RATs on the multi-SIM mobile communication device 200). In other embodiments, each baseband-RF resource chain may include physically or logically separate baseband processors (e.g., BB1, BB2).

The RF resource 218 may be a transceiver that performs transmit/receive functions for each of the SIMs/RATs on the multi-SIM mobile communication device 200. The RF resource 218 may include separate transmit and receive circuitry, or may include a transceiver that combines transmitter and receiver functions. In some embodiments, the RF resource 218 may include multiple receive circuitries. The RF resource 218 may be coupled to a wireless antenna (e.g., a wireless antenna 220). The RF resource 218 may also be coupled to the baseband modem processor 216. In some optional embodiments, the multi-SIM mobile communication device 200 may include an optional RF resource 219 configured similarly to the RF resource 218 and coupled to an optional wireless antenna 221.

In some embodiments, the general processor 206, the memory 214, the baseband processor(s) 216, and the RF resources 218, 219 may be included in the multi-SIM mobile communication device 200 as a system-on-chip 250. In some embodiments, the first and second SIMs 204a, 204b and the corresponding interfaces 202a, 202b to each subscription may be external to the system-on-chip 250. Further, various input and output devices may be coupled to components on the system-on-chip 250, such as interfaces or controllers. Example user input components suitable for use in the multi-SIM mobile communication device 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between the various software modules and functions in the multi-SIM mobile communication device 200 to enable communication between them, as is known in the art.

Functioning together, the two SIMs 204a, 204b, the baseband processor BB1, BB2, the RF resources 218, 219, and the wireless antennas 220, 221 may constitute two or more radio access technologies (RATs). For example, the multi-SIM mobile communication device 200 may be a LTE communication device that includes a SIM, baseband processor, and RF resource configured to support two different RATs, such as LTE, WCDMA, and GSM. More RATs may be supported on the multi-SIM mobile communication device 200 by adding more SIM cards, SIM interfaces, RF resources, and antennae for connecting to additional mobile networks.

In some embodiments (not shown), the multi-SIM mobile communication device 200 may include, among other things, additional SIM cards, SIM interfaces, a plurality of RF resources associated with the additional SIM cards, and additional antennae for supporting subscriptions communications with additional mobile networks.

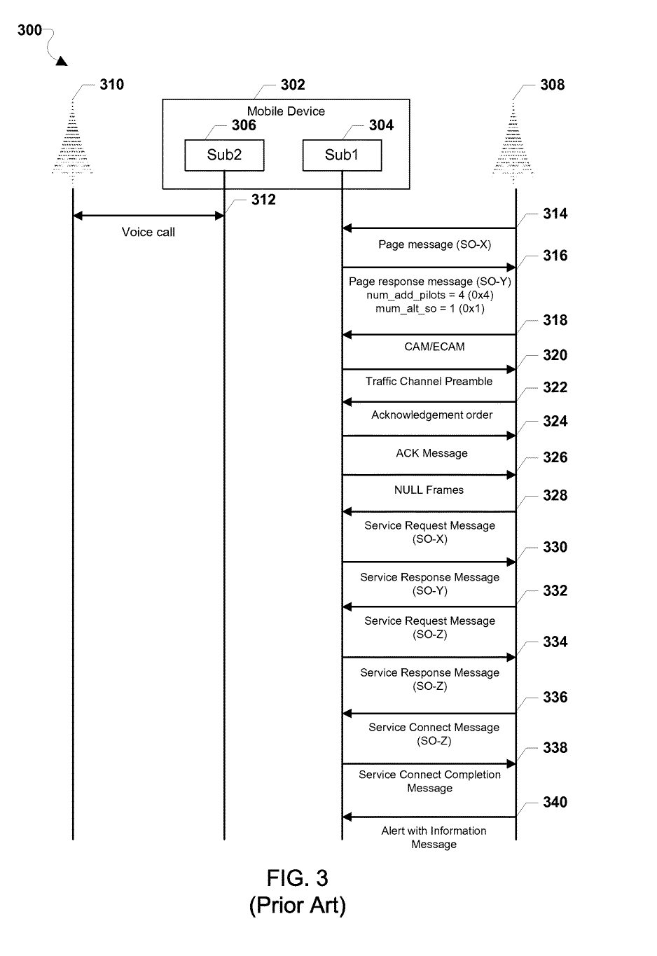

FIG. 3 illustrates call flows and message exchanges involved in a conventional process for obtaining caller ID information on a mobile communication device. With reference to FIGS. 1-3, the diagram 300 includes a mobile communication device 302 having a first subscription 304 and a second subscription 306. The mobile communication device 302 may be a MSMA device, such as a DSDA device. The first subscription 304 and the second subscription 306 may utilize separate RF receive chains on the mobile communication device 302, but share a RF transmit chain. The first subscription 304 communicates with network 308, while the second subscription 306 communicates with network 310.

The second subscription 306 may be engaged in an active voice call 312 through the network 310. During the voice call 312, the network 308 may send a page message 314 to the first subscription 304 indicating an incoming call. The page message 314 may include a proposed service option (SO), for example service option X. A service option is a communications standard that the mobile communication device and the network agree upon before establishing communication channels such as a voice or data call. For example, different service options may provide for different voice or data bit rates, or different data packet formats. The network proposes service option X in the page message 314. If the first subscription 304 supports service option X, the first subscription 304 may accept the proposed service option. If the first subscription 304 cannot support service option X, the first subscription 304 and the network 308 may engage in service negotiation (messages 328-334) to settle on an acceptable service option.

In response to receiving the page message 314, the first subscription 304 may send a page response message 316 to the network 308. The page response message 316 may include a number of different fields containing information that may be used for establishing a call between the first subscription 304 and the network 308. For example, the page response message 316 may include a proposed service option from the mobile communication device 302, such as service option Y. The page response message 316 may also include an additional pilots field (e.g., num_add_pilots) for indicating the number of additional pilot channels supported by the first subscription 304. The page response message 316 may also include an alternate service option list (e.g., num_alt_so) indicating alternate service options supported by the first subscription 304.

The network 308 may send a channel assignment message (CAM) or extended channel assignment message (ECAM) 318. The message 318 may include information for establishing a forward traffic channel between the mobile communication device 302 and the network 308. The first subscription 304 may then send a traffic channel preamble 320 to the network 308 to establish a reverse traffic channel between the mobile communication device 302 and the network 308. The network 308 may then send a base station acknowledgement order (ACK ORD) message 322, and the first subscription 304 may respond by sending an ACK message 324. The first subscription 304 may also send one or more NULL frames 326 to the network 308 until the call is established, for example up to twenty NULL transmission frames.

The first subscription 304 and the network 308 may then engage in service negotiation to agree on a service option for communication. For example, the network 308 may send a service request message 328 to the first subscription 304, proposing service option X. The first subscription 304 may not be able to support service option X, so the first subscription 304 may respond by sending a service response message 330 proposing service option Y. The network 308 may not be able to support service option Y, so the network may respond by sending a service request message 332 proposing service option Z. The first subscription 304 may be capable of supporting service option Z and may then send a service response message 334 agreeing to service option Z. Generally, the exchange of service request and response messages may continue for some time until the network 308 and the first subscription 304 agree on a service option.

After service negotiation, the network 308 may send a service connect message 336 utilizing service option Z to establish a communications channel with the first subscription 304. The first subscription 304 may respond by sending a service connect completion message 338 that confirms establishment of the communications channel. The network 308 may then send an alert with information message (AWIM) 340 that includes the caller ID information. The mobile communication device 302 may extract the caller ID information from the AWIM 340 to display to the user, either as a missed call or as a pending call. If the user decides to accept the pending call, the mobile communication device 302 may pause or disconnect the voice call 312 and establish a voice call between the first subscription 304 and the network 308.

The message exchange process for obtaining caller ID information, encompassing at least messages 314 to 340, may take up a large number of transmission frames, especially when there are several rounds of service negotiation. When the first subscription 304 and the second subscription 306 share a RF transmit chain, the message exchange process may utilize many transmission frames, which may lead to a degradation of the voice call 312.

However, not all of the messages in the message exchange process are necessary for obtaining the caller ID information. For example, because the user may have missed the call, or has not yet decided whether to accept or ignore a pending call, the first subscription 304 and the network 308 do not have to set up a full communications channel with proper service option for supporting the call. Thus, in the various embodiments the message exchange process are shortened to exclude messages or data within messages that are not necessary to obtain the caller ID information.

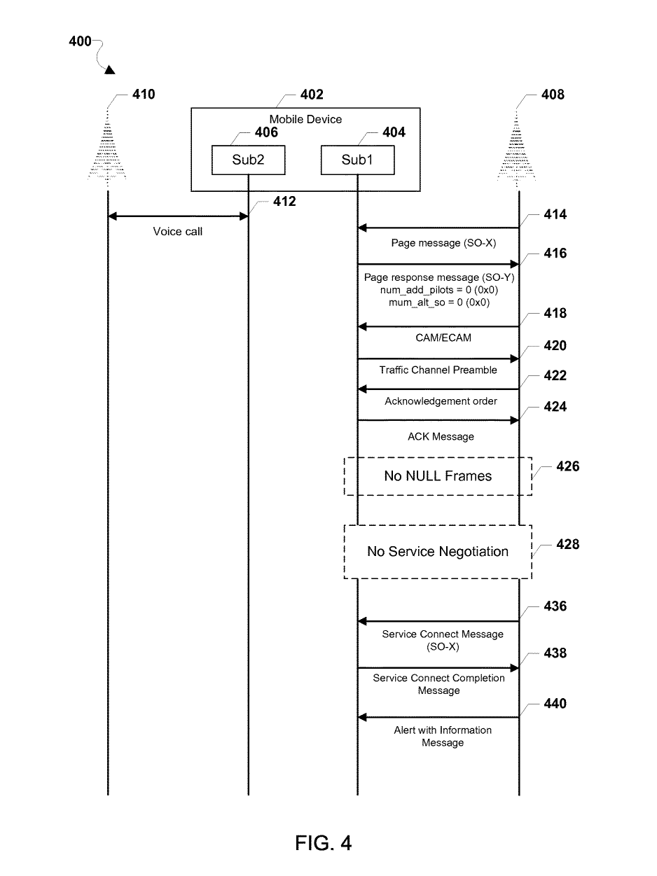

FIG. 4 illustrates a call flows and message exchanges for obtaining caller ID information on a mobile communication device according to various embodiments. With reference to FIGS. 1-2 and 4, the diagram 400 includes a mobile communication device 402 having a first subscription 404 and a second subscription 406. The mobile communication device 402 may be a MSMA device, such as a DSDA device. The first subscription 404 and the second subscription 406 may utilize separate RF receive chains on the mobile communication device 402, but share a RF transmit chain. The first subscription 404 communicates with network 408, while the second subscription 406 communicates with network 410.

The second subscription 406 may be engaged in an active voice call 412 through the network 410. During the voice call 412, the network 408 may send a page message 414 to the first subscription 304 indicating an incoming call. The page message 414 may include a service option (SO), for example service option X.

In response to receiving the page message 414, the first subscription 404 may send a page response message 416 to the network 308. The page response message 416 may include a number of different fields containing information that may be used for establishing a call between the first subscription 304 and the network 408. Some of these fields may not be necessary in order to obtain caller ID information from the network 408. For example, the additional pilots field (e.g., num_add_pilots) for indicating the number of additional pilot channels supported by the first subscription 404 may not be necessary, and so the field may be excluded or set to zero. The alternate service option list (e.g., num_alt_so) for indicating alternate service options supported by the first subscription 404 may also not be necessary, and so the list may be excluded or set to zero. This reduces the number of transmission frames needed to transmit the page response message 416. For example, a page response message that includes all fields (e.g., the message 316) may use up to fourteen transmission frames while the page response message 416 with some fields excluded may use up to eight transmission frames.

The network 408 may send a channel assignment message (CAM) or extended channel assignment message (ECAM) 418. The message 418 may include information for establishing a forward traffic channel between the mobile communication device 402 and the network 408. The first subscription 404 may then send a traffic channel preamble 420 to the network 408 to establish a reverse traffic channel between the mobile communication device 402 and the network 408. The network 408 may then send a base station acknowledgement order (ACK ORD) message 422, and the first subscription 404 may respond by sending an ACK message 424. However, the first subscription 404 may refrain from sending one or more NULL frames to the network 408 in operation 426. These NULL frames are usually sent until the call is established, but may be skipped if the first subscription 404 is only trying to obtain the caller ID information.

The first subscription 404 may also blindly accept the service option proposed by the network 408 (e.g., service option X) in operation 428 so that no service negotiation takes place. The first subscription 404 may accept the proposed service option regardless of whether the first subscription is capable of supporting the service option. The service option is used to support a call between the first subscription 404 and the network 408, but because the call may not be established (e.g., if the user declines the call or missed the call) it is not necessary to agree upon a service option at this point. Skipping the service negotiation also reduces the number of transmission frames used by the first subscription 404 to communicate with the network 408.

After the first subscription 404 blindly accepts the proposed service option, the network 408 may send a service connect message 436 to establish a communications channel with the first subscription 404. The first subscription 404 may respond by sending a service connect completion message 438 that confirms establishment of the communications channel. The network 408 may then send an AWIM 440 that includes the caller ID information. The mobile communication device 402 may extract the caller ID information from the AWIM 440 to display to the user, either as a missed call or as a pending call. If the user decides to accept the pending call, the mobile communication device 402 may pause or disconnect the voice call 412 and establish a voice call between the first subscription 404 and the network 408. Thus, by reducing the size of the page response message 416, refraining from sending NULL frames, and skipping the service negotiation, the first subscription 404 may obtain the caller ID information with less disruption to the voice call 412.

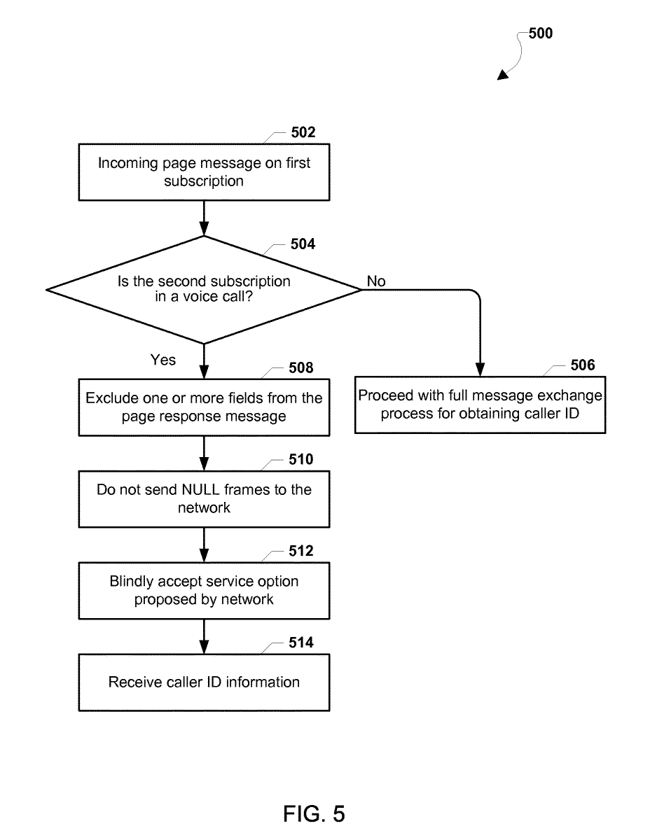

FIG. 5 illustrates a method 500 for obtaining caller ID information for a first subscription on a mobile communication device when a second subscription on the mobile communication device is in a voice call according to various embodiments. With reference to FIGS. 1-2 and 4-5, the method 500 may be implemented with a processor (e.g., the general processor 206, the baseband modem processor 216, a separate controller, and/or the like) of a mobile communication device (such as the mobile communication devices 110, 120, 200) that supports two or more SIMs/subscriptions. The first and second subscriptions may utilize separate RF receive chains but share a RF transmit chain.

In block 502, the device processor may receive an incoming page message from a network associated with the first subscription. The page message may indicate an incoming voice call through the first subscription on the mobile communication device. The page message may include a proposed service option for supporting the voice call.

In determination block 504, the device processor may determine whether the second subscription is currently engaged in a voice call. In response to determining that the second subscription is not engaged in a voice call (i.e., determination block 504=“No”), the device processor may proceed to obtain the caller ID information through the full messaging exchange process in a conventional manner in block 506. For example, the device processor may include all fields in the page response message (e.g., the message 316), send NULL frames to the network (e.g., the NULL frames 326), and engage in service negotiation with the network (e.g., the messages 328-334).

In response to determining that the second subscription is engaged in a voice call (i.e., determination block 504=“Yes”), the device processor may exclude one or more fields from the page response message in block 508. The page response message may be generated and sent to the network after receiving the page message. However, not all the information that is usually included in the page response message is necessary to obtain the caller ID information. For example, the additional pilots field and/or the alternate service options list may be excluded from the page response message. Excluding these fields may decrease the number of transmission frames necessary to transmit the page response message.

In block 510, the device processor may also refrain from sending one or more NULL frames to the network. The NULL frames may usually be transmitted after acknowledging the base station acknowledge order (e.g., the order 422) until the call is established. However, transmitting the NULL frames is unnecessary simply to obtain the caller ID information. In block 512, the device processor may blindly accept the proposed service option sent by the network, and thus skip service negotiation with the network. The service negotiation is used by the network and the mobile communication device to agree to a service option for supporting the call. However, it is not necessary to agree on a service option that is supported by both the network and the first subscription in order to obtain the caller ID information. Thus, the device processor may blindly accept the proposed service option even if the first subscription cannot support such an option.

In block 514, the device processor may receive the caller ID information from the network. The caller ID information may be included in an alert with information message sent by the network after agreeing on a service option and establishing a service connection. In this manner, the method 500 provides a shorter message exchange process for obtaining caller ID information so as to reduce disruption of an ongoing voice call.

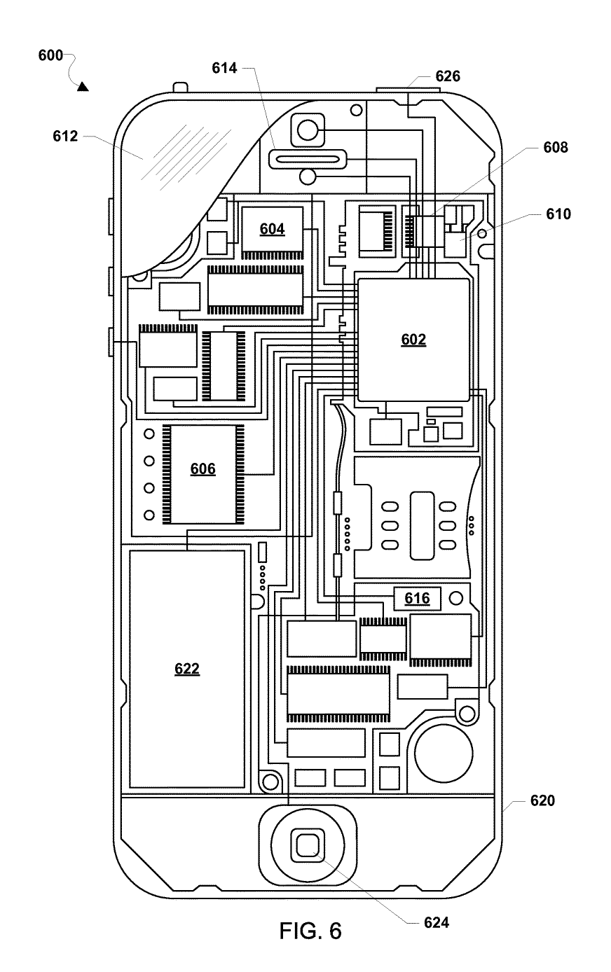

Various embodiments may be implemented in any of a variety of communication devices, an example of which (e.g., multi-SIM mobile communication device 600) is illustrated in FIG. 6. With reference to FIGS. 1-2 and 4-6, the multi-SIM mobile communication device 600 may be similar to the mobile communication devices 110, 120, 200, as described. As such, the multi-SIM mobile communication device 600 may implement the method 500 according to various embodiments.

The multi-SIM mobile communication device 600 may include a processor 602 coupled to a touchscreen controller 604 and an internal memory 606. The processor 602 may be one or more multi-core integrated circuits designated for general or specific processing tasks. The internal memory 606 may be volatile or non-volatile memory, and may also be secure and/or encrypted memory, or unsecure and/or unencrypted memory, or any combination thereof. The touchscreen controller 604 and the processor 602 may also be coupled to a touchscreen panel 612, such as a resistive-sensing touchscreen, capacitive-sensing touchscreen, infrared sensing touchscreen, etc. Additionally, the display of the multi-SIM mobile communication device 600 need not have touch screen capability.

The multi-SIM mobile communication device 600 may have one or more cellular network transceivers 608 coupled to the processor 602 and to one or more antennas 610 and configured for sending and receiving cellular communications. The one or more transceivers 608 and the one or more antennas 610 may be used with the herein-mentioned circuitry to implement various embodiment methods. The multi-SIM mobile communication device 600 may include one or more SIM cards 616 coupled to the one or more transceivers 608 and/or the processor 602 and may be configured as described herein.

The multi-SIM mobile communication device 600 may also include speakers 614 for providing audio outputs. The multi-SIM mobile communication device 600 may also include a housing 620, constructed of a plastic, metal, or a combination of materials, for containing all or some of the components discussed herein. The multi-SIM mobile communication device 600 may include a power source 622 coupled to the processor 602, such as a disposable or rechargeable battery. The rechargeable battery may also be coupled to the peripheral device connection port to receive a charging current from a source external to the multi-SIM mobile communication device 600. The multi-SIM mobile communication device 600 may also include a physical button 624 for receiving user inputs. The multi-SIM mobile communication device 600 may also include a power button 626 for turning the multi-SIM mobile communication device 600 on and off.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configurations. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc in which disks usually reproduce data magnetically, while discs reproduce data optically with lasers. Combinations of the storage media are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to some embodiments without departing from the spirit or scope of the written description. Thus, the present disclosure is not intended to be limited to the embodiments shown herein but is to be accorded the widest scope consistent with the following claims and the principles and novel features disclosed herein.

What is claimed is:

1. A method for obtaining caller identification (ID) information on a wireless communication device configured to support a first subscription and a second subscription, comprising:
receiving a page message for the first subscription from a network;
determining whether the second subscription is currently engaged in a voice call; and
in response to determining that the second subscription is currently engaged in the voice call:
excluding one or more fields from a page response message sent from the first subscription to the network;
blindly accepting a proposed service option sent by the network; and
receiving caller ID information from the network.

2. The method of claim 1, wherein the one or more fields from a page response message comprises at least one of an additional pilots field and an alternate service option list.

3. The method of claim 1, wherein receiving caller ID information from the network is performed even when the first subscription cannot support a call using the proposed service option sent by the network.

4. The method of claim 1, further comprising refraining from sending one or more null frames to the network.

5. The method of claim 1, wherein the first subscription and the second subscription share a radio frequency (RF) transmit chain of the wireless communication device.

6. The method of claim 1, wherein the page message includes the proposed service option.

7. The method of claim 1, wherein the caller ID information is included in an alert with information message sent by the network.

8. A wireless communication device, comprising:
a memory;
a radio frequency resource; and
a processor coupled to the memory and the radio frequency resource, and configured with processor-executable instructions to:
receive a page message for a first subscription from a network;
determine whether a second subscription is currently engaged in a voice call; and
in response to determining that the second subscription is currently engaged in the voice call:
exclude one or more fields from a page response message sent from the first subscription to the network;
blindly accept a proposed service option sent by the network; and
receive caller identification (ID) information from the network.

9. The wireless communication device of claim 8, wherein the processor is further configured with processor-executable instructions such that the one or more fields comprises at least one of an additional pilots field and an alternate service option list.

10. The wireless communication device of claim 8, wherein the processor is further configured with processor-executable instructions such that receiving caller ID information from the network is performed even when the first subscription cannot support a call using the proposed service option sent by the network.

11. The wireless communication device of claim 8, wherein the processor is further configured with processor-executable instructions refrain from sending one or more null frames to the network.

12. The wireless communication device of claim 8, wherein the first subscription and the second subscription share a transmit chain of the radio frequency resource of the wireless communication device.

13. The wireless communication device of claim 8, wherein the page message includes the proposed service option.

14. The wireless communication device of claim 8, wherein the caller ID information is included in an alert with information message sent by the network.

15. A wireless communication device, comprising:
means for receiving a page message for a first subscription from a network;
means for determining whether the second subscription is currently engaged in a voice call; and
means for excluding one or more fields from a page response message sent from the first subscription to the network in response to determining that the second subscription is currently engaged in the voice call;
means for blindly accepting a proposed service option sent by the network; and
means for receiving caller identification (ID) information from the network.

16. A non-transitory processor-readable medium having stored thereon processor-executable instructions configured to cause a processor of a wireless communication device to perform operations comprising:
receiving a page message for a first subscription from a network;
determining whether a second subscription is currently engaged in a voice call; and
in response to determining that the second subscription is currently engaged in the voice call:
excluding one or more fields from a page response message sent from the first subscription to the network;
blindly accepting a proposed service option sent by the network; and
receiving caller identification (ID) information from the network.

17. The non-transitory processor-readable medium of claim 16, wherein the stored processor-executable instructions are configured to cause the processor to perform operations such that the one or more fields comprise at least one of an additional pilots field and an alternate service option list.

18. The non-transitory processor-readable medium of claim 16, wherein the stored processor-executable instructions are configured to cause the processor to perform operations such that the processor receives caller ID information from the network even when the first subscription cannot support a call using the proposed service option sent by the network.

19. The non-transitory processor-readable medium of claim 16, wherein the stored processor-executable instructions are configured to cause the processor to perform operations further comprising refraining from sending one or more null frames to the network.

20. The non-transitory processor-readable medium of claim 16, wherein the first subscription and the second subscription share a radio frequency (RF) transmit chain.

21. The non-transitory processor-readable medium of claim 16, wherein the page message includes the proposed service option.

22. The non-transitory processor-readable medium of claim 16, wherein the caller ID information is included in an alert with information message sent by the network.
